(19) United States
(12) Patent Application Publication
(10) Pub. No.: US 2026/0302373 A1
(43) Pub. Date: Oct. 1, 2026

(54) SECONDARY BATTERY HAVING MULTILAYER ELECTRODE ASSEMBLY AND METHOD OF MANUFACTURING THE SAME

(71) Applicant: SAMSUNG SDI CO., LTD., Yongin-si, Gyeonggi-do (KR)

(72) Inventor: Sangwon BYUN, Yongin-si, Gyeonggi-do (KR)

(21) Appl. No.: 19/479,812

(22) PCT Filed: Mar. 11, 2024
(86) PCT No.: PCT/KR2024/003080

§ 371 Date: Oct. 29, 2025

(30) Foreign Application Priority Data
Feb. 21, 2024 (KR) 10-2024-0025225

(51) Int. Cl. H01M 10/0587; H01M 10/052; H01M 50/103; H01M 50/15; H01M 50/538; H01M 50/586; H01M 50/593

(52) U.S. Cl. CPC H01M 10/0587; H01M 10/052; H01M 50/103; H01M 50/15; H01M 50/538; H01M 50/586; H01M 50/593

(57) ABSTRACT

The present disclosure relates to a secondary battery having a structure in which a plurality of electrode assemblies are layered, and a method of manufacturing the same, and the technical problem to be solved is to propose a secondary battery with a structure in which a plurality of electrode assemblies are layered in a single battery case, which can be used as an alternative in applications in which secondary battery products are arrayed to form a battery module/pack. To this end, the secondary battery includes a case of a secondary battery, a plurality of electrode assemblies vertically layered and accommodated in the case and on which electrode tabs are formed, a current collector connected to each of the electrode tabs of the plurality of layered electrode assemblies, and a cap plate which is bonded to the case and with which a terminal connected to the current collector is assembled.

### TECHNICAL FIELD

The present disclosure relates to a secondary battery, and more specifically, to a secondary battery having a structure in which a plurality of electrode assemblies are layered and a method of manufacturing the same.

### BACKGROUND ART

In general, a secondary battery includes an electrode assembly accommodated inside a case, current collectors connected to electrode tabs (a positive tab and a negative tab) of the electrode assembly, and terminals connected to the current collectors and exposed to the outside. The electrode assembly is manufactured by winding or stacking positive and negative electrode plates and a separator. The current collectors are connected to the electrode tabs formed on the positive and negative electrode plates of the electrode assembly and are electrically connected to the terminals.

As electric vehicles and energy storage systems (ESSs) spread, the capacity of secondary batteries is increasing, and in response thereto, the capacity of secondary batteries may be increased in the form of a module or pack in which a plurality of secondary batteries are assembled. In addition, secondary batteries in the form of tall cell, which increases the capacity and has a form in which a vertical length (height) is greater than a horizontal length, are also being used.

The above information disclosed in this Background section is for enhancement of understanding of the background of the present disclosure, and therefore, it may contain information that does not constitute a related (or prior) art.

### DISCLOSURE

### Technical Problem

The present disclosure is directed to providing a secondary battery with a structure in which a plurality of electrode assemblies are layered in a single battery case, which can be used as an alternative in applications in which secondary battery products are arrayed to form a battery module/pack.

Aspects and features of the present disclosure are not limited to those described above, and other aspects and features not specifically mentioned herein will be clearly understood by those skilled in the art from the description of the present disclosure below.

### Technical Solution

One aspect of the present invention to solve the above technical problem provides a secondary battery which includes a case of a secondary battery, a plurality of electrode assemblies which are vertically layered and accommodated in the case and on which electrode tabs are formed, a current collector connected to each of the electrode tabs of the plurality of layered electrode assemblies, and a cap plate which is bonded to the case and with which a terminal connected to the current collector is assembled.

Another aspect of the present invention to solve the above technical problem provides a method of manufacturing a secondary battery, which includes preparing a plurality of electrode assemblies, manufacturing a case in which the plurality of electrode assemblies are accommodated, manufacturing a current collector configured to connect the plurality of electrode assemblies to terminals, manufacturing a cap plate with which the current collector and the terminal are assembled, and vertically layering the plurality of electrode assemblies, connecting the current collector to each of the plurality of electrode assemblies, and connecting the plurality of electrode assemblies to the terminal at the cap plate.

### Advantageous Effects

According to the present disclosure, by layering a plurality of electrode assemblies within a single battery case to form a secondary battery, compatibility with the existing electrode assembly is made possible, and thus effects of process simplification, reduction in material management burden, and reduction in production costs can be achieved.

In addition, since the secondary battery can be used as a replacement in applications such as electric trucks that conventionally use modules/packs by layering secondary batteries in two or more layers, the secondary battery can contribute to weight reduction, miniaturization, and price reduction of the relevant applications.

Effects of the present disclosure are not limited to those described above, and other effects not specifically mentioned herein will be clearly understood by those skilled in the art from the description of the present disclosure below.

### DESCRIPTION OF DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings, in which:

FIG. 1 is a top perspective view illustrating a prismatic secondary battery;

FIG. 2 is a cross-sectional view along line I-I′ of FIG. 1 that shows the inside of a secondary battery with a side-tab structure;

FIG. 3 is a cross-sectional view along line I-I′ of FIG. 1 that shows the inside of a secondary battery with a top-tab structure;

FIG. 4 is a diagram illustrating a secondary battery (tall cell) of which a vertical length is greater than a horizontal length;

FIGS. 5 and 6 are schematic diagrams illustrating a configuration of a secondary battery according to one embodiment of the present disclosure, wherein FIG. 5 is a cross-sectional view illustrating an assembled state, and FIG. 6 is an exploded view illustrating the secondary battery before being accommodated in a case;

FIG. 7 is an equivalent circuit illustrating the secondary battery according to one embodiment of the present disclosure shown in FIGS. 5 and 6;

FIG. 8 is a cross-sectional view illustrating a secondary battery including current collectors in a modified form compared to FIG. 5;

FIG. 9 is an equivalent circuit diagram illustrating the secondary battery shown in FIG. 8;

FIG. 10 is a cross-sectional schematic diagram illustrating the inside of a secondary battery additionally including a third-layer electrode assembly according to another embodiment of the present disclosure;

FIG. 11 is an equivalent circuit diagram illustrating the secondary battery according to the embodiment shown in FIG. 10;

FIGS. 12 and 13 are a cross-sectional view and an exploded view illustrating another embodiment of a secondary battery including a multilayered electrode assembly according to the present disclosure;

FIG. 14 is an exemplary diagram illustrating a secondary battery module in which secondary batteries manufactured according to the present disclosure are disposed;

FIG. 15 is an exemplary diagram illustrating a secondary battery pack including the secondary battery module shown in FIG. 14; and

FIG. 16 is a conceptual diagram illustrating a vehicle including the secondary battery pack of FIG. 15.

### MODES OF THE INVENTION

Hereinafter, embodiments of the present disclosure will be described, in detail, with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her invention in the best way. The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be further understood that the terms “include,” “including,” “comprise,” and/or “comprising” used in this specification specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements.

References to two compared elements, features, etc. as being “the same” may mean that they are “substantially the same.” Thus, the phrase “substantially the same” may include a case having a deviation that is considered low in the art, for example, a deviation of 5% or less. In addition, uniformity of a parameter in a predetermined region may imply uniformity from an average perspective.

Although the terms first, second, and the like are used to describe various components, these components are substantially not limited by these terms. These terms are only used for distinguishing one component from another component, and unless otherwise stated, it is of course that a first component may also be a second component.

Throughout the specification, unless otherwise specifically stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list.

Throughout the specification, if “A and/or B” is stated, it means A, B or A and B, unless otherwise stated and if “C to D” is stated, it means C or more and D or less, unless otherwise stated.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to limit the present disclosure.

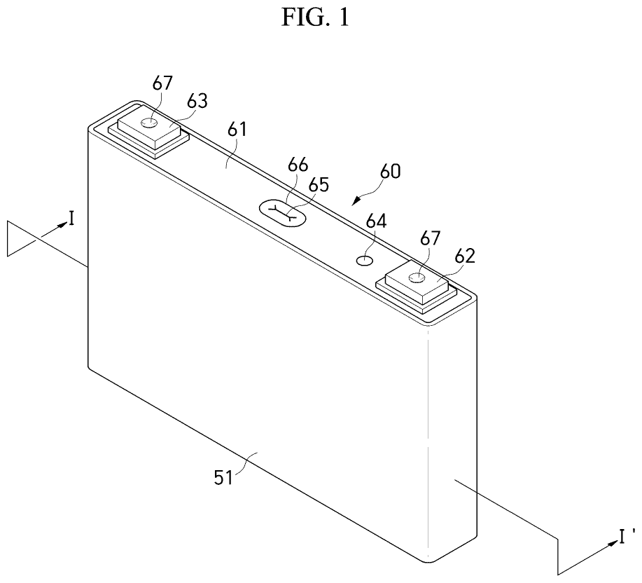

FIG. 1 is a top perspective view illustrating the exterior of a secondary battery.

A case 51 forms the overall exterior of the secondary battery and may be formed of a conductive metal such as aluminum, an aluminum alloy, or nickel-plated steel. In addition, the case 51 may provide a space in which an electrode assembly is accommodated.

The cap assembly 60 may include a cap plate 61 covering an opening of the case 51, and the case 51 and the cap plate 61 may be made of a conductive material. Here, a first terminal 62 and a second terminal 63 may be electrically connected to an internal positive or negative electrode plate and may be installed to pass through and protrude outward from the cap plate 61.

An electrolyte inlet 64 in which a seal stopper may be installed may be formed in the cap plate 61, and a vent 66 in which a notch 65 is formed may be installed. The vent 66 is for degassing a gas generated inside the battery.

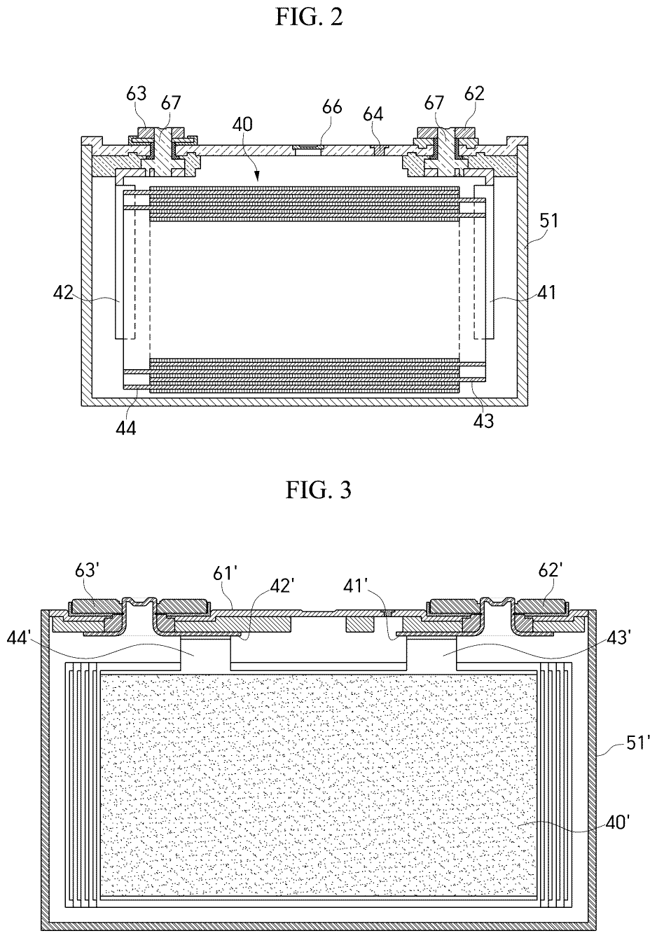

FIG. 2 is a cross-sectional view along line I-I′ of FIG. 1 that shows the inside of the secondary battery according to one form. The shown secondary battery basically includes an electrode assembly 40, a first current collector 41, a first terminal 62, a second current collector 42, a second terminal 63, and a cap assembly 60.

An electrode assembly 40 may be formed in the form of a stack in which a first electrode plate, a separator, and a second electrode plate, which are formed in a plate shape or a film shape, are wound or stacked. When the electrode assembly 40 is a wound type (referred to as a jelly roll), a winding axis may be parallel to a longitudinal direction of the case. Alternatively, the electrode assembly 40 may be a stacked type rather than the winding type. However, in the present disclosure, the shape of the electrode assembly 40 is not limited thereto. Additionally, the electrode assembly 40 may be a Z-stack electrode assembly in which a first electrode plate and a second electrode plate are inserted on both sides of a separator bent in a Z shape. In addition, the electrode assembly 40 may be accommodated inside the case by layering long sides of one or more electrode assemblies to be adjacent to each other, and the number of electrode assemblies is not limited in the present disclosure. The first electrode plate of the electrode assembly 40 may serve as a negative electrode and the second electrode plate thereof may serve as a positive electrode, or vice versa.

The first electrode plate is formed by applying a first electrode active material, such as graphite or carbon, on a first electrode current collector (substrate) made of metal foil, such as copper, a copper alloy, nickel, or a nickel alloy, and may include a first electrode tab (or a first uncoated portion) which is a region in which the first electrode active material is not applied. A first electrode tab 43 may be a passage for a current flow between the first electrode plate and the first current collector 41. In some embodiments, the first electrode tab 43 may be formed by being cut to protrude toward one side in advance when the first electrode plate is manufactured or may protrude further toward one side than the separator without a separate cut.

The second electrode plate is formed by applying a second electrode active material, such as a transition metal oxide, on a substrate made of a metal foil, such as aluminum or an aluminum alloy and may include a second electrode tab 44 (or a second uncoated portion) which is a region in which the second electrode active material is not applied. The second electrode tab 44 may be a passage for a current flow between the second electrode plate and the second current collector 42. In some embodiments, the second electrode tab 44 may be formed by being cut to protrude toward the other side in advance when the second electrode plate is manufactured and may further protrude toward the other side than the separator without a separate cut.

In some embodiments, the first electrode tab 43 may be located on a side surface of a right side of the electrode assembly 40, and the second electrode tab 44 may be located on a side surface of a left side of the electrode assembly 40 or located on one surface in the same direction. In addition, in some embodiments, the first electrode tab 43 and the second electrode tab 44 may be located at an upper portion of the electrode assembly 40.

Here, the left side, right side, and upper portion are for convenience of description based on the secondary battery shown in FIG. 1, and the positions may change when the secondary battery is rotated left and right or up and down.

The separator serves to allow movement of lithium ions and prevent a short circuit between the first electrode plate and the second electrode plate. The separator may be made of, for example, a polyethylene film, a polypropylene film, or a polyethylene-polypropylene film.

The first electrode tab 43 of the first electrode plate and the second electrode tab 44 of the second electrode plate extend from both ends of the electrode assembly 40. In some embodiments, the electrode assembly 40 may be accommodated in the case 51 together with an electrolyte.

In the electrode assembly 40, the first electrode tab 43 and the second electrode tab 44 protruding toward both ends from the first electrode plate and the second electrode plate may be connected to the first current collector 41 and the second current collector 42, respectively, by welding. As described above, when the first electrode tab 43 and the second electrode tab 44 are located at the upper portion of the electrode assembly 40 in some embodiments, the first current collector and the second current collector are located above the electrode assembly 40.

The first current collector 41 and the second current collector 42 may be connected to the first terminal 62 and the second terminal 63, respectively, which are described in FIG. 1, through connection members 67. In some embodiments, outer surfaces of the connection members 67 may be screw-machined and fastened to the first terminal 62 and the second terminal 63 through screw coupling. However, the present disclosure is not limited thereto, and the connection members 67 may be coupled to the first terminal 62 and the second terminal 63 by riveting or welding.

As described above, the secondary battery shown in FIG. 2 has a structure in which the electrode assembly 40 is disposed so that the first electrode tab 43 and the second electrode tab 44 of the electrode assembly 40 are located on both sides of the secondary battery, and this structure is referred to as a side-tab structure.

FIG. 3 is an exemplary diagram illustrating a secondary battery having an internal structure different from that of FIG. 2. FIG. 3 shows a top-tab structure in which an electrode assembly 40′ is disposed to locate a first electrode tab 43′ and a second electrode tab 44′ in an upper portion of the secondary battery.

The secondary battery with the top-tab structure shown in FIG. 3 has a structure in which the first electrode tab 43′ and the second electrode tab 44′ of the electrode assembly 40′ are located in an upper portion of the case 51′, a first current collector 41′ and a second current collector 42′ are connected to the first electrode tab 43′ and the second electrode tab 44′, respectively, and a first terminal 62′ and a second terminal 63′ connected to the current collectors 41′ and 42′, respectively, are installed on an outer side of a cap plate 61′. Other components are similar to those of the secondary battery with the side-tab structure shown in FIG. 2.

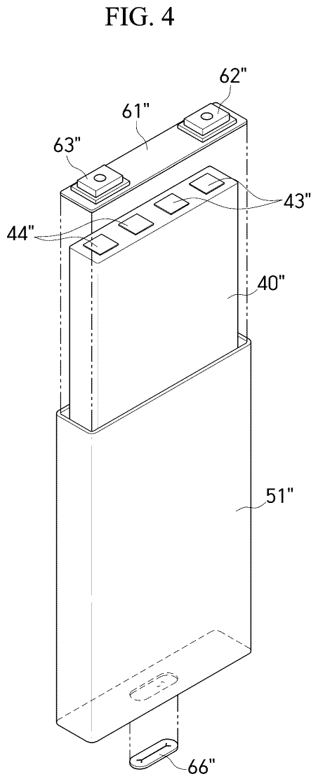

FIG. 4 shows a secondary battery in a form in which a vertical length is greater than a horizontal length. A secondary battery with a relatively long vertical length in this way is also referred to as a “tall cell.” FIG. 4 schematically illustrates a tall cell with a top-tab structure in which electrode tabs 43″ and 44″ are located on an upper surface of an electrode assembly 40″. Additionally, in a tall cell, when space is limited due to a short length of a cap plate 61″, a vent 66″ may be installed at a bottom of a case 51″, but the present disclosure is not limited thereto.

The tall cell may be alternatively used in applications in which a battery module/pack is formed (e.g., electric trucks, etc.) by arraying “horizontal rectangular secondary batteries” with a small length compared to width in two or more layers, as shown in FIG. 1. However, since the vertical length of the internal electrode assembly increases in the tall cell, when the side-tab structure is applied, there is a disadvantage in that a winding or stacking process of manufacturing the electrode assembly becomes more complicated and it is difficult for the tall cell to be compatible with the electrode assembly for a horizontal rectangular battery. In addition, when the top-tab structure is applied to the tall cell, due to the electrode tab, the current collector, and related members that should be located at the upper portion of the electrode assembly, the utilization of an upper space of the battery may be reduced and a battery capacity may be sacrificed.

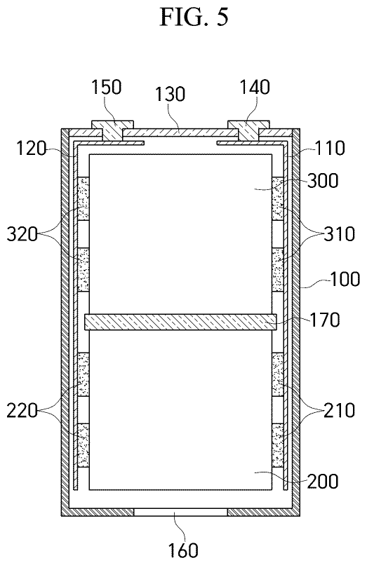

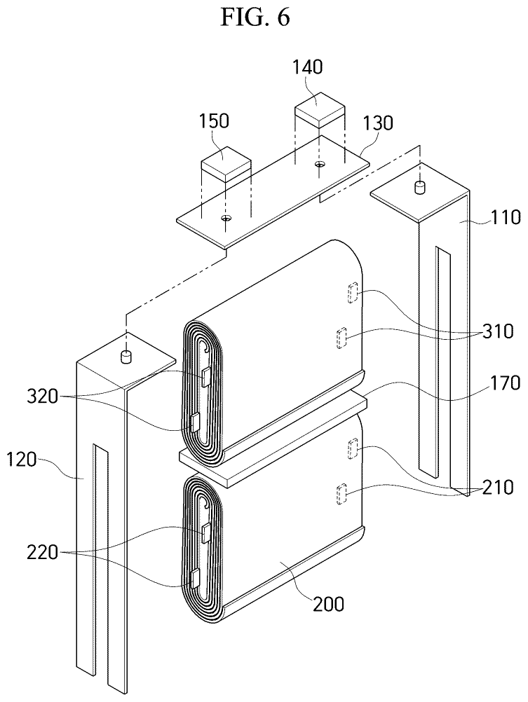

FIGS. 5 and 6 schematically show a configuration of a secondary battery according to one embodiment of the present disclosure. FIG. 5 is a cross-sectional view illustrating a state in which electrode assemblies 200 and 300, related members, and a cap plate 130 are assembled with a case 100. FIG. 6 shows a state in which a plurality of electrode assemblies 200 and 300 are stood up and layered vertically, and current collectors 110 and 120 are connected to electrode tabs 210, 310, 220, and 320 formed on both sides of the electrode assemblies 200 and 300 and connected to terminals 140 and 150 on an outer surface (upper surface) of a cap plate 130 (showing a state before being built into the case 100).

As shown in FIGS. 5 and 6, according to one embodiment of the present disclosure, the first-layer electrode assembly 200 and the second-layer electrode assembly 300 may be stood up and layered vertically in the case 100.

As shown in the drawings, the secondary battery of the present embodiment may be implemented in a side-tab structure. For example, the first-layer electrode assembly 200 may be disposed such that the first electrode tab 210 and the second electrode tab 220 of the first-layer electrode assembly 200 are located on both side surfaces of the case 100. Similarly, the second-layer electrode assembly 300 may be disposed such that the first electrode tab 310 and the second electrode tab 320 are located on both side surfaces of the case 100.

The first terminal 140 and the second terminal 150 may be assembled with the cap plate 130 bonded to the upper portion of the case 100 and may be electrically connected to the first current collector 110 and the second current collector 120, respectively.

The first current collector 110 may be connected to the first electrode tab 210 of the first-layer electrode assembly 200 and the first electrode tab 310 of the second-layer electrode assembly 300, and the uppermost portion of the first current collector 110 may be connected to the first terminal 140. Similarly, the second current collector 120 may be connected to the second electrode tab 220 of the first-layer electrode assembly 200 and the second electrode tab 320 of the second-layer electrode assembly 300, and the uppermost portion of the second current collector 120 may be connected to the second terminal 150.

An insulator 170 may be interposed between the first-layer electrode assembly 200 and the second-layer electrode assembly 300. The insulator 170 may perform insulation action to reinforce electrical insulation between the first-layer and second-layer electrode assemblies 200 and 300 and prevent mutual heat transfer.

In one embodiment, the secondary battery may be implemented in the form of a tall cell as shown in FIG. 5, and a vent 160 may be located at a bottom of the case 100.

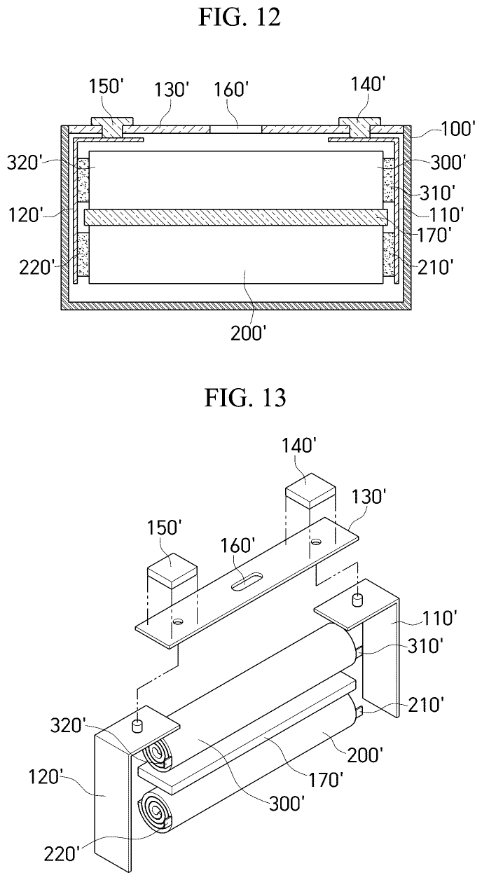

However, the secondary battery may be implemented in a form other than the tall cell (for example, the horizontal rectangular form in FIG. 2) and implemented as a secondary battery with the vent 160 located at an upper portion thereof (see FIG. 12).

In the embodiment of FIG. 5, since the first-layer and second-layer electrode assemblies 200 and 300 layered vertically are compatible with the existing single-layer electrode assembly, each of the electrode assemblies 200 and 300 may be manufactured using the same existing manufacturing equipment. Here, each of the electrode assemblies 200 and 300 may be a wound type (referred to as a jelly roll) electrode assembly of electrode plates (including a positive electrode, a separator, and a negative electrode) or may be a stacked type or Z-stacked type electrode assembly of electrode plates.

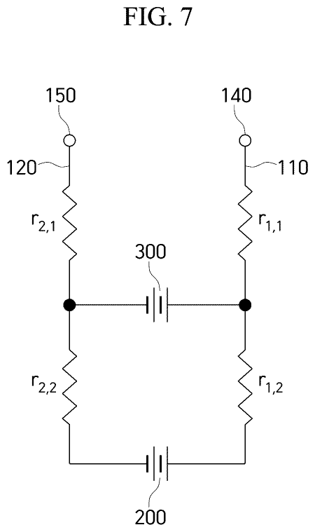

FIG. 7 is an equivalent circuit illustrating the secondary battery according to one embodiment of the present disclosure shown in FIGS. 5 and 6.

First, it is assumed that a basic line resistance of the first current collector 110 connecting the first terminal 140 and the first-layer electrode assembly 200 and the second-layer electrode assembly 300 is r_{1,1,} and a basic line resistance of the second current collector 120 connecting the second terminal 150 and the first-layer electrode assembly 200 and the second-layer electrode assembly 300 is r_{2,1}.

Structurally, since the first-layer electrode assembly 200 and the second-layer electrode assembly 300 are layered vertically, as shown in FIGS. 5 and 6, lengths of the first current collector 110 and the second current collector 120 extend from a second layer to a first layer so that an additional line resistance r_{1,2} may be added to the basic line resistance r_{1,1} of the first current collector 110, and an additional line resistance r_{2,2} may be added to the basic line resistance r_{2,1} of the second current collector 120. That is, the line resistances from the first and second current collectors 110 and 120 to the second-layer electrode assembly 300 may be r_{1,1} and r_{2,1,} and the line resistances to the first-layer electrode assembly 200 may be [r_{1,1}+r_{1,2}] and [r_{2,1}+r_{2,2}].

In this way, since the lengths of the current collectors on both sides extend vertically, as a current path increases, the line resistance for the electrode assemblies 200 and 300 may accumulate. This may cause a resistance imbalance between the first-layer electrode assembly 200 and the second-layer electrode assembly 300, resulting in a difference in current density and degradation between the electrode assemblies.

In order to solve these problems and maintain a resistance balance between the upper and lower electrode assemblies, according to one embodiment, each electrode assembly may be manufactured such that the resistances of the first-layer electrode assembly 200 and the second-layer electrode assembly 300 are different. For example, the electrode assembly may be manufactured such that the resistance of the first-layer electrode assembly 200 is smaller than the resistance of the second-layer electrode assembly 300. However, in other embodiments, a plurality of electrode assemblies may have the same resistance.

According to another embodiment for maintaining the resistance balance between the upper and lower electrode assemblies, each of the electrode assemblies 200 and 300 may be manufactured such that a number of electrode plate windings or a number of layers of the second-layer electrode assembly 300 is different from a number of electrode plate windings or a number of stacks of the first-layer electrode assembly 200. For example, the capacity of the electrode assembly may be the same but the resistance thereof may be increased by reducing the number of electrode plate windings or the number of stacks of the upper second-layer electrode assembly 300, and the capacity of the electrode assembly may be the same but the resistance thereof may be decreased by increasing the number of electrode plate windings or the number of stacks of the lower first-layer electrode assembly 200.

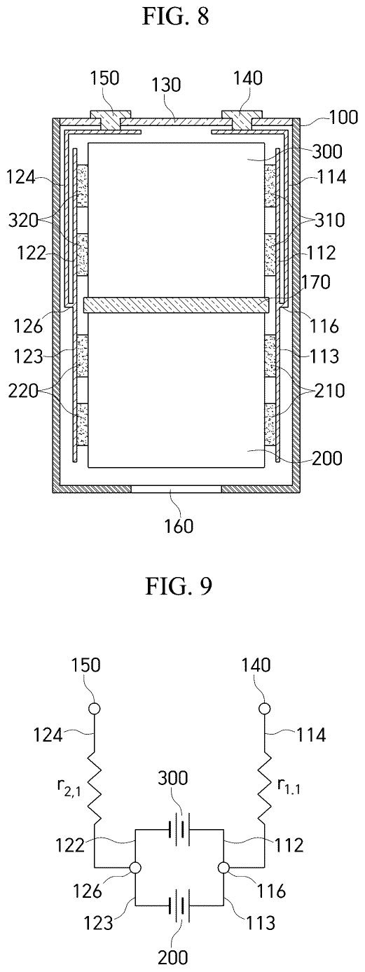

According to another embodiment for maintaining the resistance balance between the upper and lower electrode assemblies, the first-layer electrode assembly 200 and the second-layer electrode assembly 300 may be used with the same number of electrode plate windings or stacks, but the shape of the current collector may be modified. This embodiment is shown in FIG. 8.

A secondary battery shown in FIG. 8 has a modified shape of the current collector compared to the embodiment of FIG. 5. Specifically, a first current collector connecting a first terminal 140 to a first-layer electrode assembly 200 and a second-layer electrode assembly 300 may include a main line 114 connected to the first terminal 140, a first branch line 112 branching from an end of the main line 114 and connected to a first electrode tab 310 of the second-layer electrode assembly 300, and a second branch line 113 branching from an end of the main line 114 and connected to a first electrode tab 210 of the first-layer electrode assembly 200. A point where the first branch line 112 and the second branch line 113 branch from the main line 114 is shown as a branch point 116.

Specifically, a second current collector connecting a second terminal 150 to the first-layer electrode assembly 200 and the second-layer electrode assembly 300 may include a main line 124 connected to the second terminal 150, a first branch line 122 branching from an end of the main line 124 and connected to a second electrode tab 320 of the second-layer electrode assembly 300, and a second branch line 123 branching from an end of the main line 124 and connected to a second electrode tab 220 of the first-layer electrode assembly 200. A point where the first branch line 122 and the second branch line 123 branch from the main line 124 is shown as a branch point 126.

Although structures of the first and second current collectors have been conceptually described in FIG. 8, in actual implementation, the structures in which a space occupied by these current collectors in the case is minimized may be designed.

FIG. 9 is an equivalent circuit diagram of a secondary battery to which the first and second current collectors with the same structures as shown in FIG. 8 are applied.

Since the first branch line 112 and the second branch line 113 branch from the main line 114 connected to the first terminal 140 at the same length, only a basic line resistance r_{1,1} of the main line 114 may be present. In the branch lines 112 and 113, which are connected to the first-layer electrode assembly 200 and the second-layer electrode assembly 300, respectively, there may only be individual line resistances, but a line resistance imbalance therebetween cannot be present.

In addition, on the opposite side, since the first branch line 122 and the second branch line 123 branch from the main line 124 connected to the second terminal 150 at the same length, only a basic line resistance r_{2,1} of the main line 124 may be present. In the branch lines 122 and 123, which are connected to the first-layer electrode assembly 200 and the second-layer electrode assembly 300, respectively, there may only be individual line resistances, but a line resistance imbalance therebetween cannot be present.

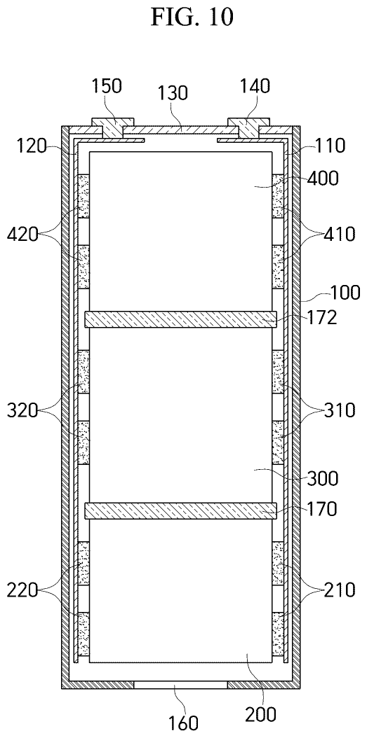

FIG. 10 is a cross-sectional schematic diagram illustrating the inside of a secondary battery additionally including a third-layer electrode assembly according to another embodiment of the present disclosure. A third-layer electrode assembly 400 is additionally layered above the first-layer electrode assembly 200 and the second-layer electrode assembly 300 described above.

A first current collector 110 may be connected to a first electrode tab 210 of a first-layer electrode assembly 200, a first electrode tab 310 of a second-layer electrode assembly 300, and a first electrode tab 410 of the third-layer electrode assembly 400, and the uppermost portion of the first current collector 110 may be connected to a first terminal 140. Similarly, a second current collector 120 may be connected to a second electrode tab 220 of the first-layer electrode assembly 200, a second electrode tab 320 of the second-layer electrode assembly 300, and a second electrode tab 420 of the third-layer electrode assembly 400, and the uppermost portion of the second current collector 120 may be connected to a second terminal 150.

An insulator 170 may be interposed between the first-layer electrode assembly 200 and the second-layer electrode assembly 300, and an insulator 172 may be interposed between the second-layer electrode assembly 300 and the third-layer electrode assembly 400. As described above, these insulators 170 and 172 are for electrical insulation and thermal insulation between the electrode assemblies 200, 300, and 400.

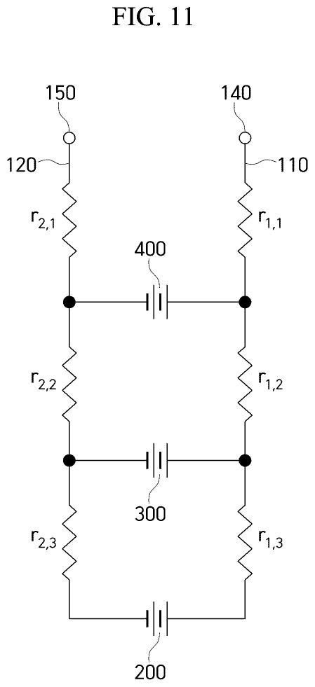

FIG. 11 is an equivalent circuit diagram illustrating the secondary battery according to the embodiment shown in FIG. 10.

Since the first-layer, second-layer, and third-layer electrode assemblies 200 are layered vertically, lengths of the first current collector 110 and the second current collector 120 extend from a third layer to a first layer. Therefore, additional line resistances r_{1,2} and r_{1,3} may be added to the basic line resistance r_{1,1} of the first current collector 110, and additional line resistances r_{2,2} and r_{2,3} may be added to the basic line resistance r_{2,1} of the second current collector 120.

As described above, as a method of solving the resistance imbalance problem between the electrode assemblies 200, 300, and 400 due to an accumulated line resistance as the lengths of the two current collectors on both sides increase, each of the electrode assemblies 200, 300, and 400 may be manufactured such that a number of electrode plate windings or stacks of the third-layer electrode assembly 400 is different from the number of electrode plate windings or stacks of the second-layer electrode assembly 300 and the number of electrode plate windings or stacks of the first-layer electrode assembly 200. For example, the resistance may be reduced while maintaining the same capacity by increasing the number of electrode plate windings or stacks from the upper layer toward the lower layer. That is, [the number of electrode plate winding or stacks of the third-layer electrode assembly 400]<[the number of electrode plate winding or stacks of the second-layer electrode assembly 400]<[the number of electrode plate winding or stacks of the first-layer electrode assembly 400] is satisfied.

FIGS. 12 and 13 are a cross-sectional schematic diagram and an exploded perspective view illustrating still another embodiment of a secondary battery including a multilayered electrode assembly according to the present disclosure.

This embodiment shows that the spirit of the present disclosure is implemented in a horizontal rectangular secondary battery (see FIGS. 1 and 2) rather than the tall cell-type secondary battery (see FIGS. 4, 5, and 6) described above.

A second-layer electrode assembly 300′ is layered on a first-layer electrode assembly 200′ in the form of a jelly roll on which electrode plates are wound, and an insulator 170′ may be interposed therebetween.

A first current collector 110′ may be connected to a first electrode tab 210′ of the first-layer electrode assembly 200 and a first electrode tab 310′ of the second-layer electrode assembly 300, and the uppermost portion of the first current collector 110′ may be connected to a first terminal 140′. In addition, the second current collector 120′ may be connected to a second electrode tab 220′ of the first-layer electrode assembly 200′ and a second electrode tab 320 of the second-layer electrode assembly 300′, and the uppermost portion of the second current collector 120′ may be connected to a second terminal 150′.

In the present embodiment, unlike the tall cell type of FIG. 5, it can be seen that a vent 160′ is installed in an upper cap plate 130′.

Even in the present embodiment, a resistance imbalance issue may occur due to the extension of the lengths of the current collectors 110′ and 120′, and the measures for the resistance imbalance issue are similar to those described above. That is, each of the electrode assemblies 200′ and 300′ may be manufactured such that a number of electrode plate windings of the second-layer electrode assembly 300′ is different from a number of electrode plate windings of the second-layer electrode assembly 200′. For example, the capacity of the electrode assembly may be the same but the resistance thereof may be increased by reducing the number of electrode plate windings of the upper second-layer electrode assembly 300′, and the capacity of the electrode assembly may be the same but the resistance thereof may be decreased by increasing the number of electrode plate windings of the lower first-layer electrode assembly 200′. In addition, as shown in FIG. 8, the first-layer electrode assembly 200′ and the second-layer electrode assembly 300′, which have the same number of windings, may be used and the shapes of the current collectors may be modified.

The embodiments described above are examples of two-layer layering of two electrode assemblies and three-layer layering of three electrode assemblies, but the spirit of the present disclosure may be generalized to layering N layers of an arbitrary number N of two or more electrode assemblies. The N-layer layered structure of the N electrode assemblies and the structure of the current collectors and related components according to the N-layer layered structure may be easily formed by those skilled in the art.

Now, a method of manufacturing a secondary battery according to the present disclosure will be described. As described above, the method of manufacturing a secondary battery of the present disclosure may be easily inferred from the secondary battery structure in which N electrode assemblies are vertically layered in N layers inside a case. Therefore, the following description of the manufacturing method will be briefly made with reference to the previously described drawings and related content.

The method of manufacturing a secondary battery of the present disclosure may include preparing a plurality of electrode assemblies including electrode tabs, manufacturing a case in which the plurality of electrode assemblies are accommodated, manufacturing current collectors connected to the electrode tabs of the plurality of electrode assemblies and configured to connect the electrode tabs to terminals, manufacturing a cap plate with which the current collectors and the terminals are assembled, vertically layering the plurality of electrode assemblies, connecting the current collectors to the electrode tabs, connecting the plurality of electrode assemblies to the terminals on the cap plate, accommodating the vertically layered electrode assembly and the current collectors in the case, and bonding the cap plate to the case.

Each operation will be described.

In the preparing of the plurality of electrode assemblies, the electrode assembly may be manufactured in a wound type (jelly roll), stacked type, or Z-stacked type electrode assembly. The electrode tab of the electrode assembly may be formed to provide a secondary battery with a side-tab structure, but the present disclosure is not limited thereto.

The electrode assembly may be manufactured such that the capacities of the plurality of electrode assemblies are the same, but the present disclosure is not limited thereto. Resistances of the electrode assemblies may be different for each electrode assembly. For example, the electrode assembly may be manufactured such that the resistance of the electrode assembly located at a lower layer is smaller than the resistance of the electrode assembly located at an upper layer. However, in other embodiments, the resistance of the plurality of electrode assemblies may be the same. A number of electrode plate windings or stacks in the electrode assembly may be different for each electrode assembly. For example, the number of electrode plate windings or stacks of the electrode assembly located at the upper layer may be smaller than the number of electrode plate windings or stacks of the electrode assembly located at the lower layer. However, in other embodiments, the numbers of electrode plate windings or stacks of the plurality of electrode assemblies may be the same.

In the manufacturing of the case, the case may be a secondary battery case with an extended vertical length relative to a horizontal length, referred to as a case for a tall cell (see FIG. 4), but the present disclosure is not limited thereto. For example, the case may be a case for a horizontal rectangular secondary battery shown in FIG. 2 (see FIGS. 12 and 13).

In the manufacturing of the current collectors, the current collectors may be connected to the electrode tabs of the plurality of electrode assemblies to connect the corresponding electrode tabs to external terminals. The current collectors may be formed as a pair of current collectors to be connected to the electrode tabs formed on both sides of the plurality of vertically layered electrode assemblies and may be manufactured with an extended length corresponding to a vertical height of the multilayer layered electrode assembly (see FIGS. 5, 6, and 10). In other embodiments, as shown in FIG. 8, the current collector may include the main line connected to the terminal, and branch lines branching from the main line and connected to electrode tabs of each electrode assembly.

In the manufacturing of the cap plate to which the current collector and the terminal are assembled, the cap plate may or may not include a vent (e.g., in the case of a tall cell). In addition, an injection port for injecting an electrolyte into the cap plate after the cap plate is attached to the case may be formed in the cap plate.

In the vertical layering of the plurality of electrode assemblies, the connecting of the current collectors to the electrode tabs, and the connecting of the plurality of electrode assemblies to the terminals on the cap plate, the current collector may be located on a surface of the cap plate facing the inside of the case among surfaces of the cap plate, and the terminal may be located on an outer surface of the cap plate (see FIGS. 5, 6, and 12 for a connection relationship between the electrode tab of the electrode assembly, the current collector, the terminal, and the cap plate). When the electrode assemblies are layered, an insulator may be interposed between the electrode assemblies.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90 ≤a≤1.8, 0≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO4 (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt% to about 99.5 wt% on the basis of 100 wt% of the positive electrode active material layer, and the content of the binder and the conductive material is in a range of about 0.5 wt% to about 5 wt%, respectively, on the basis of 100 wt% of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

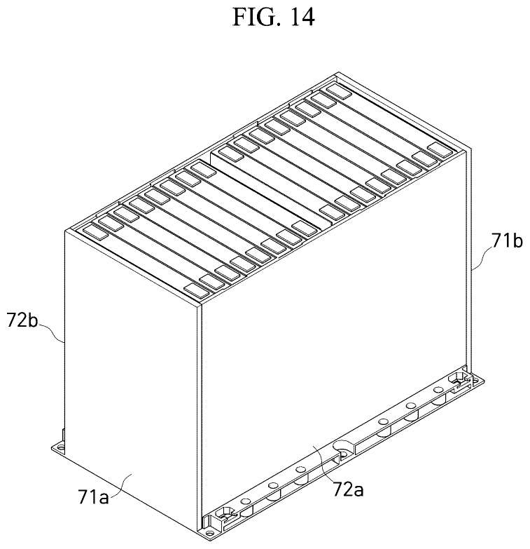

FIG. 14 is an exemplary diagram illustrating a secondary battery module in which secondary batteries manufactured according to the manufacturing method of the present disclosure are disposed. In accordance with an increase in secondary battery capacity for driving electric vehicles, a secondary battery module is manufactured by arranging and connecting a plurality of secondary battery cells in a lateral and/or vertical direction. A plurality of secondary batteries may be arrayed in a space formed by a pair of end plates 71a and 71b facing each other and a pair of side plates 72a and 72b facing each other. The arrangement of the secondary batteries may be designed to achieve desired voltage and current specifications.

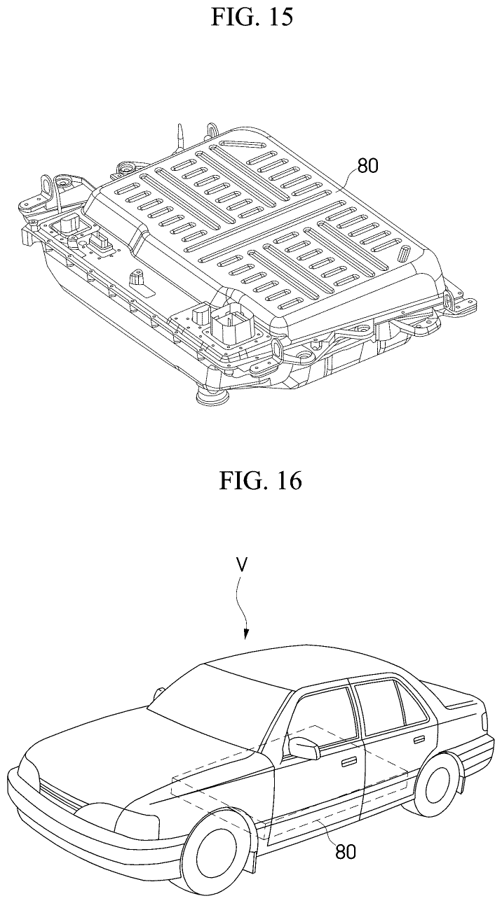

FIG. 15 is an exemplary diagram illustrating a secondary battery pack 80 formed to apply the prismatic secondary battery module shown in FIG. 14 to an actual product (e.g., a vehicle). The secondary battery pack may be manufactured by accommodating a plurality of secondary battery modules into a pack housing designed to be mounted in an actual product. The pack housing may include fasteners and electrical outlets necessary for being mounted in the product. In FIG. 11, for convenience of illustration, related elements such as bus bars for electrical connection of the secondary batteries, cooling units, and external terminals are omitted.

The secondary battery pack may be mounted in a vehicle. The vehicle may be, for example, an electric vehicle, a hybrid vehicle, or a plug-in hybrid vehicle. The vehicle may be a four-wheel drive or two-wheel drive vehicle. FIG. 16 is a diagram for describing a vehicle including the secondary battery pack shown in FIG. 15. FIG. 16 illustrates the secondary battery pack 80 according to one embodiment of the present disclosure mounted on a lower portion of a vehicle body of a vehicle V. The vehicle V operates by receiving power from the secondary battery pack 80 according to one embodiment of the present disclosure.

Although the present disclosure has been described above with respect to embodiments thereof, the present disclosure is not limited thereto. Various modifications and variations can be made thereto by those skilled in the art within the spirit of the present disclosure as defined by the appended claims and their equivalents.

### DESCRIPTION OF REFERENCE NUMERALS

40, 40′, and 40″: electrode assemblies, 41 and 41′: first current collectors, 42 and 42′: second current collectors, 43, 43′, and 43″: first electrode tabs, 44, 44′, and 44″: second electrode tabs, 50: cap assembly, 51, 51′, and 51″: cases, 60: cap assembly, 61, 61′, and 61″: cap plates, 62 and 62′: first terminals, 63 and 63′: second terminals, 64: electrolyte inlet, 65: notch, 66 and 66″: vents, 67: connection member, 71a and 71b: end plates, 72a and 72b: side plates, 80: secondary battery pack, 100: case, 110 and 110′: first current collectors, 112: first branch line, 113: second branch line, 114: main line, 116: branch point, 120 and 120′: second collectors, 122: first branch line, 113: second branch line, 124: main line, 126: branch point, 130 and 130′: cap plates, 140 and 140′: first terminals, 150 and 150′: second terminals, 160 and 160′: vents, 170, 170′, and 172: insulators, 200 and 200′: first-layer electrode assemblies, 210 and 210′: first electrode tabs, 220 and 220′: second electrode tabs, 300 and 300′: second-layer electrode assemblies, 310 and 310′: first electrode tabs, 320 and 320′: second electrode tabs, 400: third-layer electrode assembly, 410: first electrode tab, 420: second electrode tab, r_{1,1}: basic line resistance of first collector 110, r_{1,2} and r_{1,3}: additional line resistances of first collector 110, r_{2,1}: basic line resistance of second collector 120, r_{2,2} and r_{2,3}: additional line resistances of second collector 120, V: vehicle

1. A secondary battery, comprising:
a case;
a plurality of electrode assemblies which are vertically layered and accommodated in the case and on which electrode tabs are formed;
a current collector connected to each of the electrode tabs of the plurality of electrode assemblies; and
a cap plate bonded to the case, the cap plate being assembled with a terminal connected to the current collector.

2. The secondary battery as claimed in claim 1, wherein the plurality of electrode assemblies are of a wound type, stacked type, and Z-stacked type.

3. The secondary battery as claimed in claim 1, wherein the plurality of electrode assemblies comprise electrode assemblies having the same capacity.

4. The secondary battery as claimed in claim 1, wherein the plurality of electrode assemblies comprise electrode assemblies having different resistances.

5. The secondary battery as claimed in claim 4, wherein a resistance of an electrode assembly located at a lower layer of the plurality of electrode assemblies is smaller than a resistance of an electrode assembly located at an upper layer of the plurality of electrode assemblies.

6. The secondary battery as claimed in claim 1, wherein the plurality of electrode assemblies comprise electrode assemblies in which one of a number of electrode plate windings and a number of stacks is different.

7. The secondary battery as claimed in claim 6, wherein, among the plurality of electrode assemblies, one of the number of electrode plate windings and the number of stacks of an electrode assembly located at an upper layer is smaller than one of the number of electrode plate windings and the number of stacks of an electrode assembly located at a lower layer.

8. The secondary battery as claimed in claim 1, wherein the current collector is connected to the electrode tabs formed on the plurality of vertically layered electrode assemblies and extends vertically.

9. The secondary battery as claimed in claim 1, wherein the current collector comprises:
a main line connected to the terminal assembled with the cap plate; and
a plurality of branch lines branching from the main line and connected one-to-one to the electrode tabs of the plurality of electrode assemblies.

10. The secondary battery as claimed in claim 1, further comprising an insulator located between the vertically layered electrode assemblies.

11. A method of manufacturing a secondary battery, comprising:
preparing a plurality of electrode assemblies;
manufacturing a case in which the plurality of electrode assemblies are accommodated;
manufacturing a current collector configured to connect the plurality of electrode assemblies to terminals;
manufacturing a cap plate with which the current collector and the terminals are assembled; and
vertically layering the plurality of electrode assemblies, connecting the current collector to each of the plurality of electrode assemblies, and connecting the plurality of electrode assemblies to the terminals at the cap plate.

12. The method as claimed in claim 11, wherein the preparing of the plurality of electrode assemblies comprises manufacturing an electrode assembly of one of a winding type, stacked type, and Z-stacked type.

13. The method as claimed in claim 11, wherein the preparing of the plurality of electrode assemblies comprises manufacturing electrode assemblies having the same capacity.

14. The method as claimed in claim 11, wherein the preparing of the plurality of electrode assemblies comprises manufacturing electrode assemblies having different resistances.

15. The method as claimed in claim 14, wherein a resistance of an electrode assembly located at a lower layer of the plurality of electrode assemblies is smaller than a resistance of an electrode assembly located at an upper layer of the plurality of electrode assemblies.

16. The method as claimed in claim 11, wherein the preparing of the plurality of electrode assemblies comprises manufacturing electrode assemblies having a different number of one of electrode plate windings and stacks.

17. The method as claimed in claim 16, wherein one of the number of electrode plate windings and the number of stacks of an electrode assembly located at an upper layer of the plurality of electrode assemblies is smaller than one of the number of electrode plate windings and the number of stacks of an electrode assembly located at a lower layer of the plurality of electrode assemblies.

18. The method as claimed in claim 11, wherein the manufacturing of the current collector comprises manufacturing a current collector connected to electrode tabs formed on the plurality of vertically layered electrode assemblies and extending vertically.

19. The method as claimed in claim 11, wherein the manufacturing of the current collector comprises manufacturing a main line connected to the terminals assembled with the cap plate, and a plurality of branch lines branching from the main line and connected to electrode tabs of the plurality of electrode assemblies.

20. The method as claimed in claim 11, further comprising interposing an insulator between the vertically layered electrode assemblies.
